(19) United States
(12) Patent Application Publication
(10) Pub. No.: US 2022/0387949 A1
(43) Pub. Date: Dec. 8, 2022

(54) SMART GAS MIXER

(71) Applicant: Linde GmbH, Pullach (DE)

(72) Inventors: Erwan SIEWERT, Pullach (DE); Nakhleh A. HUSSARY, Pullach (DE)

(21) Appl. No.: 17/756,237

(22) PCT Filed: Nov. 5, 2020
(86) PCT No.: PCT/EP2020/025494

§ 371 Date: May 19, 2022

(30) Foreign Application Priority Data
Nov. 19, 2019 (EP) 19020653.2

(51) Int. Cl. B01F 35/83; B01F 35/21; B01F 23/10; B01F 35/00

(52) U.S. Cl. CPC B01F 35/833; B01F 35/21111; B01F 23/19; B01F 35/187; B01F 2215/045

(57) ABSTRACT

A gas mixer device for mixing a plurality of gases to generate a gas mixture comprising a desired composition, wherein the gas mixer device comprises: a chassis supporting a mixing chamber for receiving the respective gas and storing said gas mixture, and a plurality of mass flow controllers configured to measure and control a mass flow of the respective gas. According to the present invention, the respective mass flow controller is configured to be releasably connected to the chassis. Furthermore, the present invention relates to a method for generating a gas mixture comprising a desired composition.

The present invention relates to a gas mixer device for generating a gas mixture (for example for welding) and a corresponding method for mixing a gas mixture from a number of gases.

In case a customer would like to have a flexible gas mixer device for a variety of gases often no suitable solution is available. Moreover, it is usually not possible to connect the gas mixer device to a welding machine or controlling system/network.

Further problems that are encountered on a regular basis are that gas mixer devices are often not capable of realizing a high accuracy of the desired gas composition as well as a wide range of flow rates at the same time. Furthermore, such systems are frequently confined to very limited range of gases and the resulting gas mixture cannot be controlled and certified. Furthermore, a change in composition can usually only be realized over a relatively long period of time and the flow rate cannot be dynamically changed during a welding job.

Thus, the problem to be solved by the present invention is to provide a device and a method for mixing a gas that reduces at least some of the above-stated difficulties.

This problem is solved by a device having the features of claim 1 and by a method having the features of claim 14.

Preferred embodiments of these aspects of the present invention are disclosed in the corresponding sub claims and are described below.

According to claim 1, a gas mixer device for mixing a plurality of gases to generate a gas mixture comprising a desired composition is disclosed, wherein the gas mixer device comprises: a chassis and a mixing chamber (e.g. a piping, a tank, or another means or container for mixing/receiving the individual gas), wherein the chassis supports the mixing chamber, and wherein the mixing chamber is configured for receiving the respective gas and particularly storing the gas mixture. Further, the gas mixer device comprises a plurality of mass flow controllers configured to measure and control a mass flow of the respective gas.

According to the present invention the respective mass flow controller can be releasably connected to the chassis, particularly for providing a flow connection between the respective mass flow controller and the mixing chamber.

Particularly, the mixing process can be realized by means of the mass flow controllers (MFC) or by comparable devices. Particularly, according to an embodiment, the chassis comprises slots, wherein the respective mass flow controller is inserted into the respective slot and thereby connected to the mixing chamber.

Particularly, according to an embodiment, the respective mass flow controller comprises an inlet connected to a gas source, an outlet for passing gas from the gas source into the mixing chamber supported by the chassis, a mass flow sensor, and a control valve, wherein the respective mass flow controller further comprises a controller which is configured to receive an input signal from a control unit of the gas mixer device, wherein the controller is configured to compare the input signal to an output value provided by the mass flow sensor and to adjust the control valve accordingly to achieve a desired mass flow. The gas sources can be formed as cylinders, bundles, tanks or mini tanks and hold the different gases that shall be mixed by the gas mixer device to form the gas mixture having the desired composition.

Furthermore, according to an embodiment, the chassis comprises a plurality of slots, wherein each slot is configured to receive one of the mass flow controllers in a releasably fashion. Particularly, the respective mass flow controller may be connected to the chassis by means of a latching connection when it is inserted into its associated slot.

Furthermore, according to an embodiment, every slot comprises electrical contacts for establishing an electrical connection to a mass flow controller so that the mass flow controller is provided with electrical energy via said electrical contacts when the mass flow controller is inserted into one of the slots. According to a further embodiment, the respective slot provides a flow connection to the mixing chamber so that the gas can flow from the gas source via the mass flow controller into the mixing chamber when the mass flow controller is inserted into one of the slots and allows passage of gas into the mixing chamber. Furthermore, according to an embodiment, the respective slot provides a communication connection between a controller of a mass flow controller and a communication unit, when the mass flow controller is inserted into a slot of the chassis of the gas mixer device.

Further, according to an embodiment, the control unit of the gas mixer device is configured to recognize a mass flow controller once the mass flow controller has been inserted into a slot of the chassis. Particularly, the control unit recognizes the specifications of the respective mass flow controller like minimum and maximum flow rate and accuracy.

Particularly, the control unit can be a computer configured to execute a control software, particularly a mobile hand-held device such as a mobile phone (for example a smart phone).

Particularly, the control unit is configured to execute a control software that is configured to receive the desired composition of the gas mixture to be mixed as input data and to provide said input data to the mass flow controllers inserted into the slots of the chassis.

Furthermore, according to an embodiment, the gas mixer device comprises a plurality of sensors, wherein the sensors are configured to monitor the composition of the gas mixture in real time upon mixing of the gas mixture by the gas mixer device.

Particularly, according to an embodiment, the respective sensor is configured to be releasably fastened to the chassis of the gas mixer device. Particularly, the control unit will automatically recognize the respective sensor and use it for monitoring the gas mixture. Particularly, by utilizing the sensors it can be recognized when the respective mass flow controller should be recalibrated.

Furthermore, according to an embodiment, the control unit of the gas mixer device is configured to track at least one of: the composition of the gas mixture, a flow rate of the gas mixture, a humidity of the gas mixture, a temperature of the gas mixture, a pressure of the gas mixture. Particularly, this data can be saved and printed as a certificate.

Furthermore, according to an embodiment, the gas mixer is configured to be connected to a welding device to provide the gas mixture to the welding device to be used in a welding process. Furthermore, particularly, the gas mixer device is configured to check fulfillment of a welding procedure specification of the welding device to ensure that a correct gas mixture is delivered to the welding device.

Particularly, according to an embodiment, the gas mixer device is configured to check the respective gas source (for example a gas cylinder) connected to the inlet of the respective mass flow controller, wherein particularly the control unit is configured to block a gas source in case it does not fulfill a pre-defined requirement (i.e. does not comprise the correct gas specification, etc.).

Furthermore, according to an embodiment, the gas mixer device is configured to adjust the composition of the gas mixture upon conducting a welding process using the welding device, e.g. according to an input signal indicative of the welding current or according to time.

Furthermore, according to an embodiment, the gas mixer device comprises a gas filter for filtering one of the following substances out of the gas mixture: oxygen, H₂O.

Further, according to an embodiment of the gas mixer device, the gas mixer device comprises at least one outlet that is in flow connection or can be brought into flow connection with the mixing chamber to supply a gas mixture mixed in the mixing chamber to said at least one outlet. Particularly, the at least one outlet is configured to be connected to a further device such as the welding device stated above.

Furthermore, according to an embodiment, the gas mixer device comprises a plurality of outlets, wherein the gas mixer device is configured to supply the respective outlet of said plurality of outlets with a gas mixture mixed by the gas mixer device. Particularly, the gas mixer device can be configured to supply the plurality of outlets with identical gas mixtures. Alternatively, the gas mixer device can be configured to supply each outlet of said plurality of outlets with a different gas mixture. The outlets may be connected to different devices needing different gas mixtures or to identical devices that shall be delivered with varying gas mixtures. Also the flow rates delivered via the respective outlets can be identical or can be different depending on the respective application.

Particularly, the gas mixer device can comprise a plurality of mixing chambers. In case the smart mixer device has a plurality of outlets, each mixing chamber can be connected or connectable to a different outlet to enable gas flow to the respective outlet. Furthermore, in case of a plurality of mixing chambers, the mixing chamber can be connected to the various outlets of the mass flow controllers on the inlet side via suitable valves (for example a multi-way valve).

According to yet another aspect of the present invention, a method for generating a gas mixture using a gas mixer device according to the present invention is disclosed, wherein the method comprises the steps of: releasably connecting a number of mass flow controllers to the chassis, wherein the inlets of the mass flow controllers are connected to different gas sources, each gas source providing a different gas, and feeding the respective gas via the respective mass flow controller into the mixing chamber to generate a gas mixture in the mixing chamber (for example a piping) that comprises a desired composition, wherein the mass flow of the respective gas into the mixing chamber is controlled by means of the respective mass flow controller.

The gas mixer device can provide gas mixtures via several outlets (cf. also above). In this way welding processes that require several gas mixtures in different flow rates like in plasma welding can be operated with a single gas mixer device. In the example of plasma welding five gases are needed (Plasma gas, shielding gas, focus gas, purging gas and trailing gas).

The gas mixture device can be used for any gas demanding application. The main applications are welding cladding and wire arc additive manufacturing (also known as WAAM).

The software of the gas mixer device is configured to monitor the gas consumption and can output a warning before the gas source is empty. The operator can choose the gas composition that is needed as well as the flow rate and accuracy as well as the outlet that should be used. Valves inside the chassis connect the mass flow controller slots to the outlet. The software will define/advise the type of mass flow controller that should be inserted into the associated slot (for example by clicking it into the chassis).

In the above-mentioned applications, constant pressure or constant flow can be required depending on the device that is used on the outlet side of the gas mixer device. The operator then has to set constant pressure or constant flow or gets this information in case the gas mixer device is connected to the welding device. In case of a constant flow, the operator has to set a flow rate value or in case of constant pressure a pressure value. In case a constant pressure is required, a pressure regulator is preferably provided upstream the respective outlet of the gas mixer device. In case of a constant mass flow, a mass flow controller is preferably provided upstream the respective outlet of the gas mixer device. At the outlet of the gas mixer device various devices may be connected that may have their own mass flow controllers (such as a welding power source).

In the following, embodiments, further features, and advantages of the present invention shall be described with reference to the FIGURE, wherein

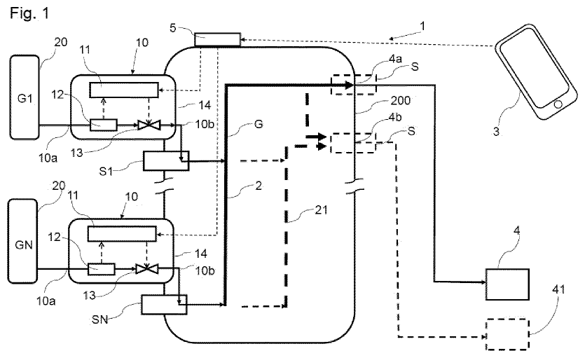

FIG. 1 shows a schematical illustration of an embodiment of a gas mixer device according to the present invention.

FIG. 1 shows an embodiment of a gas mixer device according to the present invention.

Particularly, the gas mixer device 1 is configured to mix a plurality of gases (G1, . . . , GN) contained in gas sources such as gas cylinders 20 to generate a gas mixture G comprising a desired composition. As shown in FIG. 1, the gas mixer device 1 comprises a mixing chamber 2 (e.g. in form of a piping) for receiving the respective gas (G1, . . . , GN). The size of the mixing chamber 2 may be adjusted to accommodate the needed response time of the application in question. Further, the gas mixer device comprises a chassis 200 holding the mixing chamber 2, wherein the chassis 200 is configured to receive and a number of mass flow controllers 10 corresponding to a number N of different gases G1, . . . , GN to be mixed. Particularly, the respective mass flow controller 10 is configured to be releasably connected to the chassis 200 by inserting the respective mass flow controller 10 into an associated slot 14 provided on the chassis 200.

Furthermore, the respective mass flow controller 10 comprises an inlet 10a connected to the respective gas source 20, an outlet 10b for passing the respective gas G1, . . . , GN into the mixing chamber (e.g. tubing) 2, a mass flow sensor 12 and a control valve 13, wherein the respective mass flow controller 10 further comprises a controller 11 which is configured to receive an input signal from a control unit 3 (e.g. via a communication unit 5 of the gas mixer device 1), wherein the respective controller 11 is configured to compare the input signal indicative of the desired composition of the final gas mixture G to an output value provided by the respective mass flow sensor 12 and to adjust its control valve 13 accordingly to achieve a desired mass flow (and therewith composition of the desired gas mixture G)

The mass flow controller compilation of the device 1 can now be adjusted to the welding task, regarding the type of gas, the number of gases G1, . . . , GN, the flow rate, and accuracy.

Once an MFC 10 is connected to the chassis 200 by inserting it into a slot 14 (e.g. clicked in) it is recognized by a control software executed on the control unit 3 (e.g. a mobile phone or some other computer). In the control software the gas mixture's composition to be achieved can be set. Particularly, if a gas mixture G is chosen that cannot be mixed in an optimal way by the respective MFC 10 connected to the chassis 200 the control software can give an advice what kind of MFC 10 needs to be added or changed.

Particularly, the quality of the gas mixture G is ensured by the use of calibrated MFC 10, and the right choice of the type of MFC 10 taking into account the inaccuracy and aging. Furthermore, sensors S1, . . . , SN can be used to monitor in real time the gas composition. According to an embodiment, these sensors can be clicked into the device 1 like the MFCs 10. Alternatively or in addition, a single gas sensor S may also be arranged downstream the mixing chamber 2 (e.g. at an outlet 4a of the gas mixer device 1).

Particularly, the gas mixer device 1 can be configured to automatically recognize the Sensors S1, . . . SN and use them for monitoring the gas mixture G. By using the sensors S1, . . . SN it can be recognized when the individual MFC 10 should be recalibrated.

Furthermore, the gas mixer device 1 can be configured to track the gas mixture's composition, flow rate, humidity, temperature and pressure. Particularly, this data can be saved and printed as a certificate.

Furthermore, the gas mixer device 1 can be connected (e.g. via the outlet 4a) to any other system like for example a power supply or a welding device 4. When checking the fulfillment of a welding procedure specification (WPS), the gas mixer device 1 can be configured to ensure that the right gas mixture G is used. The gas mixer device 1 can comprises a plurality of outlets 4a, 4b (for simplicity only two outlets are shown), wherein the outlets 4a, 4b can be connected to different devices 4, 41 that may need equal or different gas compositions. Several outlets 4a, 4b may also be connected to the same device. For example, one single welding station connected to several outlets 4a, 4b, . . . may receive several gas mixtures with a different composition and for example with a different flow and/or pressure. An example is a plasma application that needs shielding gas, plasma gas, focus gas, trailing gas and purging gas. Thus, the outlets 4a, 4b, . . . can be provided with the same gas mixture G or with different gas mixtures depending on the specific application. The outlets 4a, 4b, . . . can be connected to the same mixing chamber 2. However, particularly in case different mixtures are needed at the outlets 4a, 4b, . . . , the gas mixer device 1 can also comprise multiple mixing chambers 2, 21, . . . , wherein the outlets 4a, 4b can be connected to different mixing chambers 2, 21. Several mixing chambers 2, 21 can be connected to the outlets 10b of the mass flow controllers 10 on the inlet side of the gas mixer device 1 via suitable valves.

Furthermore, the flow rates of the gas mixture provided at the respective outlet 4a, 4b can be equal or different (depending on the respective application to which the respective gas mixture is provided).

As an option the gas mixer device 1 can be configured to check the connected gas cylinders 20 by e.g. using a bar code scanner and/or RFID equipped cylinders 20. Any alternative cylinder identification system could be used instead. If available also the filling certificate could be used to check if the required specification of the gas mixture G can be fulfilled.

Further, the control software of the gas mixer device 1 can be configured to block cylinders/gas sources 20 in case they do not fulfill the requirements.

Furthermore, according to an embodiment, the gas mixture's G composition can be adjusted while welding, e.g. according to signals like the welding current of the welding device 4 or according to a time or a temperature (e.g. Interpass temperature). The small size of the gas mixer device 1 allows to position the mixer 1 close to the process. In addition, as no buffer is used, the small gas volume between the MFC and the process allows very short reaction times in which the gas composition can be adjusted. Preferably, the response of the gas mixer device 1 is of the order of microseconds for optimum flexibility.

As an additional option, it is possible to implement a gas filter for filtering oxygen, humidity etc. out of the gas mixture G to ensure best quality.

1-15. (canceled)

16. A gas mixer device for mixing a plurality of gases (G1, . . . , GN) to generate a gas mixture (G) comprising a desired composition, wherein the gas mixer device comprises:
a chassis (200) supporting a mixing chamber for receiving the respective gas (G1, . . . , GN), and
a plurality of mass flow controllers (10) configured to measure and control a mass flow of the respective gas (G1, . . . , GN),
wherein
the respective mass flow controllers (10) are configured to be releasably connected to the chassis (200).

17. The gas mixer device according to claim 16, wherein the respective mass flow controller comprises an inlet connected to a gas source, an outlet for passing gas into the mixing chamber, a mass flow sensor and a control valve, wherein the respective mass flow controller further comprises a controller which is configured to receive an input signal from a control unit of the gas mixer device, wherein the controller is configured to compare the input signal to an output value provided by the mass flow sensor and to adjust the control valve accordingly to achieve a desired mass flow.

18. The gas mixer device according to claim 16, wherein the chassis comprises a plurality of slots, wherein each slot is configured to receive one of the mass flow controllers.

19. The gas mixer device according to claim 18, wherein every slot comprises electrical contacts for establishing an electrical connection to a mass flow controller so that the mass flow controller is provided with electrical energy via said electrical contacts when the mass flow controller is inserted into one of the slots, and/or wherein the respective slot provides a flow connection to the mixing chamber when the mass flow controller is inserted into one of the slots, and/or wherein the respective slot provides a communication connection between a controller of a mass flow controller and the control unit, when the mass flow controller is inserted into a slot of the chassis.

20. The gas mixer device according to claim 18, wherein the control unit of the gas mixer device is configured to recognize a mass flow controller once the mass flow controller has been inserted into a slot of the chassis.

21. The gas mixer device according to claim 17, wherein the chassis comprises a plurality of slots, wherein each slot is configured to receive one of the mass flow controllers, wherein the control unit is configured to execute a control software that is configured to receive the desired composition of the gas mixture to be mixed and/or a volume per time of the respective gas and/or mass flow rate of the respective gas as input data and to provide said input data to the mass flow controllers inserted into slots of the chassis.

22. The gas mixer device according to claim 16, wherein the gas mixer device comprises a plurality of sensors, wherein the sensors are configured to monitor the composition of the gas mixture in real time.

23. The gas mixer device according to claim 22, wherein the respective sensor is configured to be releasably fastened to the chassis.

24. The gas mixer device according to claim 17, wherein the control unit is configured to track at least one of: the composition of the gas mixture, a flow rate of the gas mixture, a humidity of the gas mixture, a temperature of the gas mixture, a pressure of the gas mixture.

25. The gas mixer device according to claim 16, wherein the gas mixer device is configured to be connected to a welding device to provide the gas mixture to the welding device to be used in a welding process, and wherein particularly the gas mixer device is configured to check fulfillment of a welding procedure specification of the welding device to ensure that a correct gas mixture is delivered to the welding device.

26. The gas mixer device according to claim 17, wherein the gas mixer device is configured to check the respective gas source connected to an inlet of a mass flow controller, wherein particularly the control unit is configured to block a gas source in case it does not fulfill a pre-defined requirement.

27. The gas mixer device according to claim 25, wherein the gas mixer device is configured to adjust the composition of the gas mixture upon conducting a welding process using the welding device.

28. The gas mixer device according to claim 16, wherein the gas mixer device comprises a gas filter for filtering one of the following substances out of the gas mixture: oxygen, H₂O.

29. The gas mixer device according to claim 16, wherein the gas mixer device comprises a plurality of outlets, wherein the gas mixer device is configured to supply the respective outlet of said plurality of outlets with a gas mixture mixed by the gas mixer device, wherein the gas mixer device is configured to supply the plurality of outlets with identical gas mixtures, or wherein the gas mixer device is configured to supply each outlet of said plurality of outlets with a different gas mixture.

30. A method for generating a gas mixture using a gas mixer device according to claim 16, comprising the steps of:
releasably connecting a number of mass flow controllers to the chassis, wherein the inlets of the mass flow controllers are connected to different gas sources containing gases to be mixed,
feeding the respective gas via the respective mass flow controller into the mixing chamber to generate a gas mixture in the mixing chamber that comprises a desired composition, wherein the mass flow of the respective gas into the mixing chamber is controlled by means of the respective mass flow controller.
